(19) United States
(12) Patent Application Publication
(10) Pub. No.: US 2021/0304594 A1
(43) Pub. Date: Sep. 30, 2021

(54) METHOD FOR SIMULATING, GRADING, AND COMPILING TWO-DIMENSIONAL OVER-LIMIT VEHICLE LOAD SPECTRUM

(71) Applicant: South China University of Technology, Guangdong (CN)

(72) Inventors: Peiyan HUANG, Guangdong (CN); Zhanbiao CHEN, Guangdong (CN); Guowen YAO, Guangdong (CN); Wen LI, Guangdong (CN); Shiya LI, Guangdong (CN); Yongchang GUO, Guangdong (CN)

(21) Appl. No.: 17/117,443

(22) Filed: Dec. 10, 2020

(30) Foreign Application Priority Data
Mar. 27, 2020 (CN) 202010227394.X

(51) Int. Cl. G08G 1/01; G06F 30/20; G06F 17/18; G08G 1/015

(52) U.S. Cl. CPC G08G 1/0137; G08G 1/0133; G08G 1/015; G06F 17/18; G06F 30/20

(57) ABSTRACT

A method for simulating, grading, and compiling a two-dimensional over-limit vehicle load spectrum, including the following steps: continuously acquiring traffic flow information of various typical roads for a period of time; generating a traffic flow series of each lane, and determining an optimal sample capacity of a traffic flow; analyzing a probability feature of the traffic flow series of each lane; simulating the traffic flow series of all the lanes; generating a two-dimensional over-limit vehicle load spectrum; grading the two-dimensional over-limit vehicle load spectrum; and compiling the two-dimensional over-limit vehicle load spectrum. Actual phenomena such as over-limit and overload in road/highway transport can be reproduced, facilitating evaluation of load effect, bearing capacity, and safety of bridge structures, and facilitating health monitoring, variable amplitude and random fatigue experiments, life prediction of the bridge structures and graded custody and safety risk control of highway/urban road bridges.

### CROSS REFERENCE TO RELATED APPLICATION

This application claims the priority of Chinese Patent Application No. 202010227394.X, filed on Mar. 27, 2020, entitled “METHOD FOR SIMULATING, GRADING, AND COMPILING TWO-DIMENSIONAL OVER-LIMIT VEHICLE LOAD SPECTRUM”, which is incorporated herein by reference in its entirety.

### TECHNICAL FIELD

The disclosure relates to the technical field of a vehicle load spectrum, and particularly, to a method for simulating, grading, and compiling a two-dimensional over-limit vehicle load spectrum.

### BACKGROUND

Vehicle over-limit/overload is common in road (highway) transport in China. Of course, not all over-limit/overload cases can cause a bridge structure to bear an excessively high load (briefly referred to as “overloading”) which is higher than a design load. However, the over-limit/overload tends to cause overload. Overload ultimately causes damages and harm to the bridge structure, and even endangers the structure and the traffic safety. Actual vehicle load spectra (including over-limit loads) of typical highways in China need to be precisely simulated and compiled, to ensure safety of existing highway bridge structures and provide a theoretical basis for improving a highway bridge design standard.

Currently, a common method for simulating a vehicle load spectrum is to acquire statistics on vehicles passing through a section of a highway or a bridge, and perform damage equivalence analysis, to obtain the probability statistic feature of vehicle models or axle loads. Then, a vehicle load-time sequence (load spectrum) is simulated by using a numerical simulation method such as a Monte Carlo method based on the statistics feature thereof. However, an existing load spectrum is a one-dimensional load spectrum, namely, including only a vehicle load-time sequence, and a change of a planar acting position of a vehicle load is not considered. In actual road transport, for a highway and a bridge that include at least two lanes in a single direction, there is a high probability that vehicle loads of the lanes on a same section at the same time are different, and load spectra thereof also are different. In addition, arbitrary lane changing is a special phenomenon in highway/road transport in China. Therefore, a one-dimensional load spectrum cannot accurately describe effects of actions caused by a vehicle load on a road and a bridge, and a two-dimensional vehicle load spectrum changing with time and space (lanes) needs to be considered.

A load spectrum of a general vehicle may not need to be compiled after being simulated if there is no other requirement such as experiment or control. However, for over-limit (exceeding a specified size or weight) vehicles, because over-limit vehicles include over-capacity (exceeding a specified capacity thereof) vehicles, and the over-capacity vehicles include overloaded (exceeding a design load of a bridge structure) vehicles, an over-limit vehicle load spectrum needs to be graded and compiled. For overloaded vehicles, different degrees of damages are caused to a bridge structure due to different overload degrees. Therefore, it is necessary to grade and compile an over-limit vehicle load spectrum, to evaluate, manage, and control safety risks of the bridge structure under vehicle overload.

Therefore, problems exist in aspects of simulating, grading, and compiling a (over-limit) vehicle load spectrum in China, namely, an existing vehicle load spectrum is a one-dimensional load spectrum (a load-time sequence). That is, only a change rule of a vehicle load with time is considered, and changing of the vehicle load with space (a lane) is not considered. Currently, there is no report of an over-limit vehicle load spectrum; there is no method for simulating, grading, and compiling an over-limit vehicle load spectrum. There is no report of a two-dimensional vehicle load spectrum; and there is no method for simulating, grading, and compiling a two-dimensional over-limit vehicle load spectrum.

### SUMMARY

Various embodiments aim to overcome defects of the prior art, and provide a method for simulating, grading, and compiling a two-dimensional over-limit vehicle load spectrum. The various embodiments of the present invention may be used for structural response analysis, safety evaluation, design, maintenance, management, risk control, and the like of a highway bridge, an urban road bridge, and a country road bridge, and may be further used for variable amplitude and/or stochastic fatigue experiment of a bridge structure under an over-limit vehicle load spectrum.

In accordance with aspects of the present invention, a method for simulating, grading, and compiling a two-dimensional over-limit vehicle load spectrum includes continuously acquiring traffic flow information of various typical roads for a period of time; generating a traffic flow series of each lane, and determining an optimal sample capacity of a traffic flow; analyzing a probability feature of the traffic flow series (effective data) of each lane: obtaining traffic flow series data, corresponding to the optimal sample capacity, of each lane based on the determined optimal sample capacity, calculating and determining a power spectral density function or an autocorrelation function thereof, and determining a probability distribution function thereof; simulating the traffic flow series of all the lanes; generating a two-dimensional over-limit vehicle load spectrum; grading the two-dimensional over-limit vehicle load spectrum; and compiling the two-dimensional over-limit vehicle load spectrum.

In various embodiments, the typical roads include a national highway, a city expressway, an expressway, and other roads. In various embodiments, acquiring traffic flow information includes using a dynamic vehicle weighing system, a snapping system, or a manual counting method. In various embodiments, the traffic flow information includes a license plate number, a passing time, a lane, a vehicle type (a quantity of vehicle axles), an axle weight, a gross weight, and a speed. In various embodiments, duration of continuously acquiring the traffic flow information is at least one month.

In various embodiments, the traffic flow series of each lane is generated by at least one of: classifying acquired vehicle data into four vehicle types based on a small-sized vehicle, a middle-sized vehicle, a large-sized vehicle, and a passenger and freight trailer, acquiring statistics on a traffic flow passing through each lane on a road segment (bridge) in a unit time, and generating a traffic flow series of each lane in a same direction; and calculating load effects of vehicles having different quantities of axles, classifying vehicles having a same quantity of axles into one category, and using a vehicle type corresponding to a highest load effect in each vehicle category as a standard vehicle type of the category; and re-acquiring statistics on acquired traffic flow data of each lane based on the standard vehicle type, to obtain a traffic flow series of each lane in a same direction.

In various embodiments, a method for determining the optimal sample capacity of the traffic flow is: setting statistical analysis precision based on a probability that an over-limit vehicle occurs in statistical data of a traffic flow of each lane, and calculating an exceedance probability of a needed quantity of over-limit vehicles, to determine an effective data amount (the optimal sample capacity), facilitating statistical analysis on the effective data.

In various embodiments, specified sampling precision in statistical analysis of a traffic flow is [symbol] =0.03˜0.05, and then, an obtained minimum sample capacity is:

$$N = ( 1 - {P}_{e} ) / ( {δ}_{{\hat{}}_{{P}_{e}}}^{2} {P}_{e} ) ,$$

where an exceedance probability of a needed quantity of over-limit vehicles in statistical samples is Pₑ=Nₒ/Nₚ, N₀ is a quantity of over-limit vehicles passing through a lane in a pre-statistical time t, and Nₚ is a total quantity of vehicles passing through the lane in the same time; if N≤Nₚ, N=Nₚ, a statistical time is set to t, and in this case, Nis an optimal sample capacity; and if N>Nₚ, the pre-statistical time t is increased until the minimum sample capacity of each lane meets N≤Nₚ.

In various embodiments, a method for simulating a traffic flow series of a lane is: determining, based on a probability distribution function of a traffic flow series (effective data) of a lane, a stochastic process attribute of the traffic flow series of the statistical analysis object: if the stochastic process attribute belongs to a Gaussian stochastic process, a probability distribution function and a power spectral density function or an autocorrelation function thereof are used and a numerical simulation method using a trigonometric series harmonic synthesis method is used, to obtain a simulated traffic flow series (a one-dimensional over-limit vehicle load spectrum), including an over-limit vehicle, of the lane; or if the stochastic process attribute of the traffic flow series is a non-Gaussian stochastic process, a simulation method combining “probability distribution transformation” and a trigonometric series harmonic synthesis method is used, and a power spectral density function of the non-Gaussian process is used as a simulation target, to obtain a simulated traffic flow series (a one-dimensional over-limit vehicle load spectrum), including an over-limit vehicle, belonging to the non-Gaussian stochastic process, of the lane through “probability distribution transformation” and by correcting the power spectral density function.

In various embodiments, the simulation method combining the “probability distribution transformation” and the trigonometric series harmonic synthesis method is a method for simulating the non-Gaussian process by using the “probability distribution transformation” and by using the Gaussian process, and includes the following steps: using the power spectral density function of the non-Gaussian process as a simulation objective function; setting an average value of a Gaussian process to zero, where a variance thereof is equal to a variance of the non-Gaussian process; simulating the Gaussian process by using the objective function; assuming that a probability of each discrete value of the simulated Gaussian process is equal to a probability of each discrete value of the non-Gaussian process, and generating (simulating) the non-Gaussian process; calculating a power spectral density function of the simulated non-Gaussian process, and comparing the power spectral density function with the objective function; and if the power spectral density function is basically consistent with the objective function, namely, a relative error is less than 3%, ending simulation; or if the power spectral density function is inconsistent with the objective function, correcting a power spectral density function of the Gaussian process in this step by using the objective function and the power spectral density function used for simulating the non-Gaussian process, and then, performing the step of simulating the Gaussian process by using the objective function, to simulate the Gaussian process until the power spectral density function of the simulated non-Gaussian process is basically consistent with the objective function.

In various embodiments, simulated traffic flow series, including over-limit vehicles, of all lanes are obtained based on the method for simulating a traffic flow series of a lane.

In various embodiments, in a process of probability distribution transformation, the power spectral density function of the Gaussian process is corrected for one to three times.

In various embodiments, a method for generating the two-dimensional over-limit vehicle load spectrum includes arranging, based on a lane sequence, simulated traffic flow series that pass through the lanes on a section of a road or a bridge at the same time, to generate the two-dimensional over-limit vehicle load spectrum that can reproduce a vehicle type/load, a vehicle passing time, and a lane location.

In various embodiments, a method for grading the two-dimensional over-limit vehicle load spectrum is: grading the two-dimensional over-limit vehicle load spectrum based on a degree of a damage (a geometric decrease degree of a fatigue life) caused by a constant amplitude load equivalent to an over-limit of the vehicle to a bridge structure and an over-limit defining method: an upper limit of a first-level load is dividing a fatigue limit of a bridge member under a constant amplitude fatigue load by a safety coefficient; an upper limit of a second-level load is a critical over-limit value of a vehicle; an upper limit of a third-level load is a value exceeding the critical over-limit value by 10%; an upper limit of a fourth-level load is a value exceeding the critical over-limit value by 25%; and a lower limit of a fifth-level load is a value exceeding the critical over-limit value by more than 25%.

In various embodiments, a method for determining a fatigue limit of a bridge member includes determining an infinite life N_{f} thereof based on a related specification, and determining a fatigue limit S_{f} thereof corresponding to N_{f} based on a fatigue experiment curve (an S˜N curve) or a classical fatigue equation of a same material or member under a constant amplitude fatigue load.

In various embodiments, the safety coefficient of the fatigue limit in the first-level load is 1.6 to 2.0.

In various embodiments, the over-limit defining method includes for a reinforced concrete member, a smaller value in a critical bending moment obtained when a tensile stress is applied on a concrete lower limb (a location of a maximum tensile stress) of a bending member and a bearing capacity limit obtained after a structural safety coefficient (K=1.6 to 2.0) is considered is used as a critical bending moment for defining over-limit, and a vehicle load corresponding to a value greater than or equal to the bending moment is defined as over-limit; and, for a steel structural member and another structural member, a bearing capacity limit obtained after a structural safety coefficient (K=2.0) is considered is used as a critical stress (a critical load, a critical bending moment) for defining over-limit, and a vehicle load corresponding to a value greater than or equal to the stress value (a load, a bending moment) is defined as over-limit.

In various embodiments, a method for compiling the two-dimensional over-limit vehicle load spectrum includes setting load values of all first-level loads in a load spectrum to zero based on the method for grading the two-dimensional over-limit vehicle load spectrum, and then compiling the needed two-dimensional over-limit vehicle load spectrum based on a sequence and locations in the original load spectrum.

The two-dimensional over-limit vehicle load spectrum can reproduce actual phenomena such as the over-limit, the overload and the oversize in highway/road transport in China, and not only can present a vehicle load-time sequence, but also can reflect a spatial location (a lane location) of a vehicle load, to lay the foundation for precise evaluation of a structural response of a bridge under the action of an actual vehicle load, bearing capacity and safety evaluation, design, consolidation maintenance, custody, and risk control of a bridge structure. According to the method for simulating a two-dimensional over-limit vehicle load spectrum of the present invention, a vehicle load-time sequence can be efficiently and precisely reproduced, a spatial location (a lane location) of a vehicle load can be efficiently and precisely simulated, and both a vehicle load stochastic process conforming to Gaussian distribution and a vehicle load stochastic process conforming to non-Gaussian distribution can be efficiently and precisely simulated.

According to the method for grading and compiling a two-dimensional over-limit vehicle load spectrum of the present invention, a method for distinguishing between and defining the over-limit, the over-limit, and the overload of vehicles is specified based on a damage accumulation (life attenuation) rule of a bridge structure under the action of stochastic loads of over-limit vehicles and the overload defining method, so that a relatively high load causing damages to the structure is sufficiently retained, a sequence and locations of original loads are not changed, it helps to compile a load spectrum (an experimental spectrum) used for a stochastic fatigue experiment and a variable amplitude fatigue experiment, and an experiment work amount can be greatly reduced.

According to the method for grading a two-dimensional over-limit vehicle load spectrum of the present invention, the method helps to evaluate and predict a service life of a bridge structure by using a classical fatigue theory and a corrected Miner linear damage accumulation criterion, a work amount of a load effect, health monitoring, and bearing capacity and safety evaluation of the bridge structure can be greatly reduced, and it helps to implement graded custody and safety risk control on a highway/road bridge.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 is a flowchart of a method for simulating, grading, and compiling a two-dimensional over-limit vehicle load spectrum, in accordance with aspects of the present invention;

FIG. 2 is a flowchart of numerical simulation of a non-Gaussian stochastic process, in accordance with aspects of the present invention;

FIG. 3 shows traffic flows of the first lane to the third lane in a period of time, in accordance with aspects of the present invention;

FIG. 4 is a schematic diagram of standard vehicle types of vehicles having different quantities of axles, in accordance with aspects of the present invention;

FIG. 5 shows a traffic flow series (a one-dimensional over-limit vehicle load spectrum) of each lane, in accordance with aspects of the present invention;

FIG. 6 shows a two-dimensional over-limit vehicle load spectrum, in accordance with aspects of the present invention; and

FIG. 7 shows a graded and compiled two-dimensional over-limit vehicle load spectrum, in accordance with aspects of the present invention.

### DETAILED DESCRIPTION

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

The following further describes in detail the inventive concepts with reference to the examples and the accompanying drawings, but implementations of the disclosure are not limited thereto.

### EXAMPLE 1

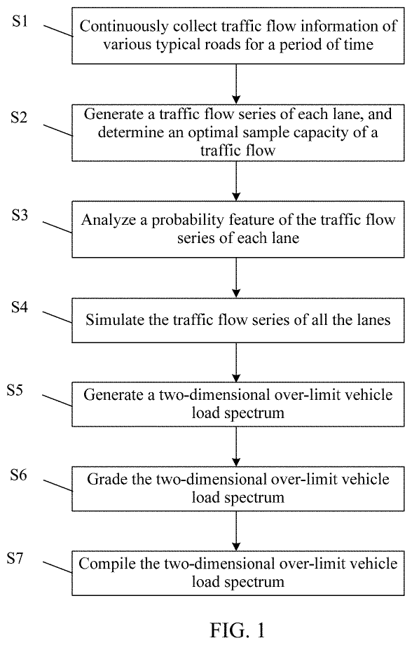

FIG. 1 is a flowchart of a method for simulating, grading, and compiling a two-dimensional over-limit vehicle load spectrum according to a first embodiment.

A first step S1 of FIG. 1 includes continuously acquiring traffic flow information of various typical roads for a period of time.

The typical roads include a national highway, a city expressway, an expressway, other roads, and the like.

Acquiring traffic flow information includes using a dynamic vehicle weighing system, a snapping system, a manual counting method, or the like.

The traffic flow information includes a license plate number, a passing time, a lane, a vehicle type (a quantity of axles), an axle weight, a gross weight, a speed, and the like.

A duration of continuously acquiring the traffic flow information is at least one month.

Then, in step S2 of FIG. 1, generate a traffic flow series, and determine an optimal sample capacity of a traffic flow.

There are two methods for generating the traffic flow series, namely: standardizing a vehicle load based on the “Technical Standard of Highway Engineering” (JTGB01-2014), classifying acquired vehicle data into four vehicle types based on a small-sized vehicle, a middle-sized vehicle, a large-sized vehicle, and a passenger and freight trailer, acquiring statistics on a traffic flow passing through each lane on a road segment (bridge) in a unit time, and generating a traffic flow series of each lane in a same direction; and calculating, based on the “Limits of Dimensions, Axle Load and Masses for Road Vehicles” (GB1589-2004) and “the Catalogue of China Cars (2012)”, load effects of vehicles having different quantities of axles, classifying vehicles having a same quantity of axles into one category, and using a vehicle type corresponding to a highest load effect in each vehicle category as a standard vehicle type of the category; and re-acquiring statistics on the acquired traffic flow data of each lane based on the standard vehicle type, to obtain a traffic flow series of each lane in a same direction.

A method for determining the optimal sample capacity of the traffic flow includes setting statistical analysis precision based on a probability that an over-limit vehicle occurs in statistical data of a traffic flows of each lane, calculating an exceedance probability of a needed quantity of over-limit vehicles, to determine an effective data amount (the optimal sample capacity), facilitating statistical analysis on effective data.

In various embodiments, specified sampling precision in statistical analysis of a traffic flow is [symbol] =0.03˜0.05, and then, an obtained minimum sample capacity is:

$$N = ( 1 - {P}_{e} ) / ( {δ}_{{\hat{}}_{{P}_{e}}}^{2} {P}_{e} ) ,$$

where an exceedance probability of a needed quantity of over-limit vehicles in statistical samples is Pₑ=N₀/Nₚ, Nₒ is a quantity of over-limit vehicles passing through a lane in a pre-statistical time t, and Nₚ is a total quantity of vehicles passing through the lane in the same time; if N≤Nₚ, N=Nₚ, the statistical time is set to t (in this case, N is an optimal sample capacity); and if N>Nₚ, the pre-statistical time t is increased until the minimum sample capacity of each lane meets N≤Nₚ.

In step S3 of FIG. 1, analyze a probability feature of the traffic flow series (effective data) of each lane: obtaining traffic flow series data, corresponding to a sample capacity greater than the minimum sample capacity, of each lane based on the determined minimum sample capacity, calculating and determining a power spectral density function or an autocorrelation function thereof, and determining a probability distribution function thereof.

In step S4 of FIG. 1, simulate the traffic flow series of all the lanes.

In various embodiments, a method for simulating a traffic flow series of a lane includes determining, based on an autocorrelation function R(τ) (or a power spectral density function S(f)) and a probability distribution function Fₓ(x) that are obtained through statistical analysis of vehicle load data of a lane, a stochastic process attribute of the traffic flow series of the statistical analysis object:

If the stochastic process attribute belongs to a Gaussian stochastic process, a probability distribution function and a power spectral density function or an autocorrelation function thereof are used and a numerical simulation method using a trigonometric series harmonic synthesis method is used, to obtain a simulated traffic flow series (a one-dimensional over-limit vehicle load spectrum), including an over-limit vehicle, of the lane, specifically:

It is assumed that a power spectral density function of a Gaussian process x(t) is S(f), a trigonometric series of x(t) is constructed, to generate a stochastic process:

$${x}^{d} ( t ) = {σ}_{x} \sqrt{\frac{2}{N}} {\sum }_{k = 1}^{N} cos ( 2 π {f}_{k} t + {ϕ}_{k} ) , \qquad ( 1 )$$

Where a variance of x(t) is:

σₓ²=∫₋₂₈ ^{+∞}S(f)df

and fₖ is a stochastic variable having a probability density function:

$$p ( ω ) = \frac{S ( f )}{{σ}_{x}^{2}} ,$$

φₖ is a stochastic variable conforming to uniform distribution on (0.2π), and N is a sufficiently large positive integer. A vehicle load-time sequence (a one-dimensional vehicle load spectrum), conforming to Gaussian distribution, of a lane can be obtained through simulation based on the formula (1).

If the stochastic process attribute of the traffic flow series is a non-Gaussian stochastic process, a simulation method combining “probability distribution transformation” and a trigonometric series harmonic synthesis method is used, and a power spectral density function of the non-Gaussian process is used as a simulation target, to obtain a simulated traffic flow series (a one-dimensional over-limit vehicle load spectrum), including an over-limit vehicle, belonging to the non-Gaussian stochastic process, of the lane through “probability distribution transformation” and by correcting the power spectral density function.

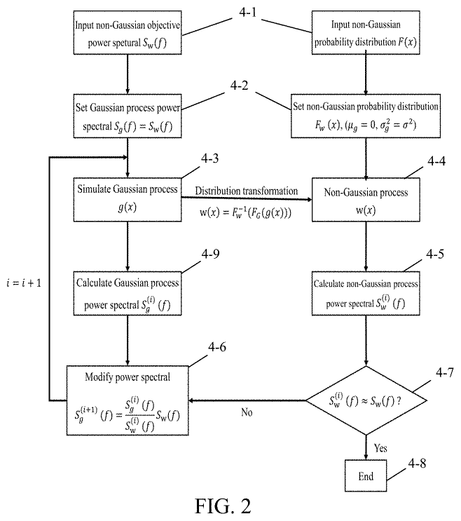

Referring to FIG. 2, in step 4-1, use the power spectral density function S_{w}(f) of the non-Gaussian process and the probability distribution function F(x) as a simulation objective function.

In step 4-2 of FIG. 2, set an average value μ_{g} of a Gaussian process to zero, where a variance σ_{g}² thereof is equal to a variance σ_{w}² of the non-Gaussian process, and power spectrum density functions are also equal, namely, S_{g}(f)=S_{w}(f).

In step 4-3 of FIG. 2, simulate the Gaussian process g(x) by using the objective function.

In step 4-4 of FIG. 2, assume that a probability of each discrete value of the simulated Gaussian process is equal to a probability of each discrete value of the non-Gaussian process, namely, w(x)=F_{w}⁻¹(F_{G}(g(x))), and generate (simulate) the non-Gaussian process w(x).

In step 4-5 of FIG. 2, calculate a power spectral density function S_{w}⁽ⁱ⁾(f)(i=1) of the simulated non-Gaussian process w(x), and compare the power spectral density function with the objective function S_{w}(f) in step 4-7 of FIG. 2. If the power spectral density function is basically consistent with the objective function, namely, a relative error is less than 3%, end a simulation process in step 4-8 of FIG. 2. If the power spectral density function is inconsistent with the objective function, perform step 4-6.

In step 4-6, correct a power spectral density function of the Gaussian process in this step by using the objective function and the power spectral density function used for simulating the non-Gaussian process, namely,

$${S}_{g}^{( i + 1 )} ( f ) = \frac{{S}_{g}^{( i )} ( f )}{{s}_{w}^{i} ( f )} {S}_{w} ( f ) ,$$

and the performing step 4-3 of simulating the Gaussian process until the power spectral density function of the simulated non-Gaussian process is basically consistent with the objective function. In step 4-9, calculate the Gaussian process power spectral S_{g}⁽ⁱ⁾(f)

In various embodiments, in a process of “probability distribution transformation”, the power spectral density function of the Gaussian process is corrected for one to three times.

This step is repeated to simulate traffic flow series of all other lanes.

In step S5 of FIG. 1, generate a two-dimensional over-limit vehicle load spectrum.

Specifically, a method for generating the two-dimensional over-limit vehicle load spectrum includes arranging, based on a lane sequence, simulated traffic flow series that pass through the lanes on a section of a road or a bridge at the same time, to generate the two-dimensional over-limit vehicle load spectrum that can reproduce a vehicle type/load, a vehicle passing time, and a lane location.

In step S6 of FIG. 1, grade the two-dimensional over-limit vehicle load spectrum.

Specifically, a method for grading the two-dimensional over-limit vehicle load spectrum includes grading the two-dimensional over-limit vehicle load spectrum based on a degree of a damage (a geometric decrease degree of a fatigue life) caused by a constant amplitude load equivalent to an over-limit of the vehicle to a bridge structure and an over-limit defining method.

A first-level load barely affects a fatigue life of a bridge structure. Therefore, an upper limit S_{1,max} of the first-level load may be set to a result of dividing a fatigue limit thereof by a safety coefficient, namely, S_{1,max}=S_{f}/(1.6−2.0).

A second-level load is a normal (safe) vehicle load that is not greater than overload. Therefore, an upper limit S_{2,max} thereof is a critical vehicle over-limit value P_{c}, σ_{c}, or M_{c} of the bridge structure. Under the action of the second-level load, a fatigue life of the bridge structure may be described by using a classical fatigue theory.

A third-level load is greater than or equal to a critical vehicle over-limit value and less than or equal to 110% of the critical vehicle over-limit value, namely, an upper limit of the third-level load is 110% of the critical over-limit value P_{c}, σ_{c}, or M_{c}.

An upper limit of a fourth-level load is 125% of the critical vehicle over-limit value, namely, 125% of the critical over-limit value P_{c}, σ_{c}, or M_{c}.

A lower limit of a fifth-level load is more than 125% of the critical vehicle over-limit value, namely, more than 125% of the critical over-limit value P_{c}, σ_{c}, or M_{c}.

Under the action of the third-level load to the fifth-level load, a fatigue life of the bridge structure may be described by using a corrected Miner linear damage accumulation criterion.

Further, a method for determining a fatigue limit of a bridge member is: determining an infinite life N_{f} thereof based on a related specification, and determining a fatigue limit S_{f} thereof corresponding to N_{f} based on a fatigue experiment curve (an S˜N curve) or a classical fatigue equation S^{m}N=C of a same material or member under a constant amplitude fatigue load.

In various embodiments, the safety coefficient of the fatigue limit in the first-level load is 1.6 to 2.0.

In various embodiments, the over-limit defining method includes, for a reinforced concrete member, a smaller value in a critical bending moment obtained when a tensile stress is applied on a concrete lower limb (a location of a maximum tensile stress) of a bending member and a bearing capacity limit (a bending moment M_{c2}) obtained after a structural safety coefficient (K=1.6 to 2.0) is considered is used as a critical bending moment Mc obtained during over-limit of a vehicle, a minimum vehicle over-limit value P_{c} is obtained by using Mc, and a vehicle load corresponding to a value greater than or equal to the bending moment is defined as over-limit, the over-limit defining method includes, for a steel structural member and another structural member, a bearing capacity limit (a stress, a bending moment) obtained after a structural safety coefficient (K=2.0) is considered is used as a critical stress σ_{c} (a critical load, a critical bending moment) obtained during over-limit, and a vehicle load corresponding to a value greater than or equal to the stress value (the load, the bending moment) is defined as over-limit.

In step S7 of FIG. 1, compile the two-dimensional over-limit vehicle load spectrum.

Specifically, a method for compiling the two-dimensional over-limit vehicle load spectrum includes setting load values of all first-level loads, which barely affects the fatigue life of the bridge structure, in a load spectrum to zero based on the method for grading the two-dimensional over-limit vehicle load spectrum, and then compiling the needed two-dimensional over-limit vehicle load spectrum based on a sequence and locations in the original load spectrum.

### EXAMPLE 2

The following further describes, with reference to an instance, the method for simulating, grading, and compiling a two-dimensional over-limit vehicle load spectrum.

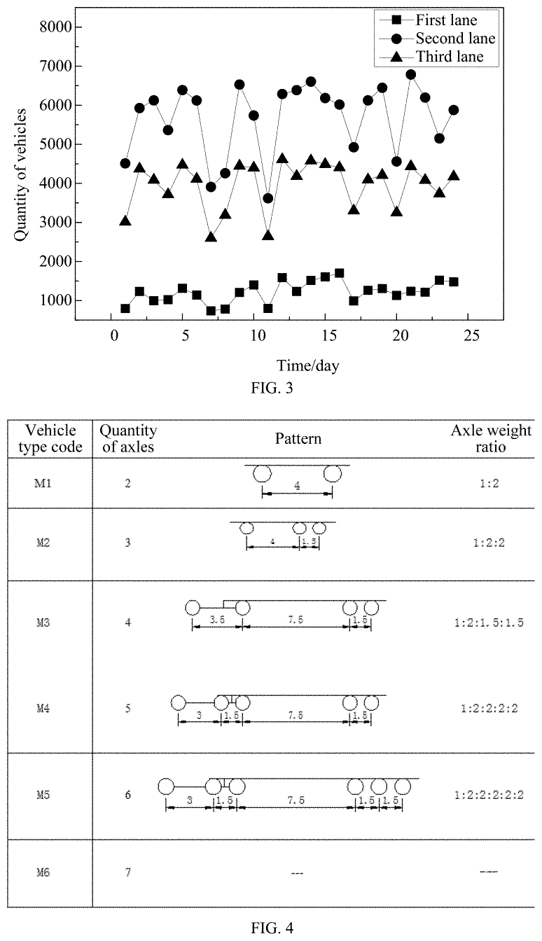

A single-amplitude expressway (highway) bridge of a city includes three lanes. In a first step, for example step S1 of FIG. 1, traffic flow data is continuously acquired for one month by using both a dynamic vehicle weighing system and a snapping system, and data of 24 days is shown in FIG. 3.

Load effects of vehicles having different quantities of axles are calculated based on “Limits of Dimensions, Axle Load and Masses for Road Vehicles” (GB1589-2004) and “the Catalogue of China Cars (2012)”, vehicles having a same quantity of axles are classified into one category based on an on-site spot check result, and a vehicle type corresponding to a highest load effect in each vehicle category is used as a calculated (standard) vehicle type of the category, as shown in FIG. 4. After the standard vehicle type is determined, statistics is re-acquired on the acquired traffic flow data of each lane based on the standard vehicle type, to obtain a traffic flow series of each lane in a same direction in a second step, for example, step S2 of FIG. 1.

Sampling precision in statistical analysis of a traffic flow is set to δ_{\hat{P}}_{ₑ}=0.05 , and a pre-statistical time is t=7 days. Total quantities Np of vehicles passing through the lanes in the pre-statistical time 7 days are respectively 9124, 43454, and 29274. Quantities N₀ of over-limit vehicles are respectively 386, 480, and 603. Then, exceedance probabilities Pₑ=N₀/Nₚ thereof are respectively 4.23%, 1.10%, and 2.06%. Quantities N=(1−Pₑ)/(0.05²Pₑ) of vehicles needing to be sampled for the lanes are respectively 9055, 35812, and 19019. Because each lane meets Nₚ>N, an optimal sample capacity of current statistical data is a traffic flow in t=7 days, namely, N=Nₚ.

In a third step, for example, step S3 of FIG. 1, a power spectral density function or an autocorrelation function thereof is calculated and determined for traffic flow series data of each lane in 7 days, and a probability distribution function thereof is determined. Power spectral density functions of the three lanes are respectively:

$${S}_{1} ( f ) = \frac{1}{2} [ \frac{1}{{2.66}^{2} \times {10}^{- 8} + 4 {{π}^{2} ( f + 0.418 )}^{2}} + \frac{1}{{2.66}^{2} \times {10}^{- 8} + 4 {{π}^{2} ( f - 0.418 )}^{2}} ] ;$$

$${S}_{2} ( f ) = \frac{1}{2} [ \frac{1}{{0.207}^{2} \times {10}^{- 8} + 4 {{π}^{2} ( f + 0.418 )}^{2}} + \frac{1}{{0.207}^{2} \times {10}^{- 8} + 4 {{π}^{2} ( f - 0.418 )}^{2}} ] ; and$$

$${S}_{3} ( f ) = \frac{1}{2} [ \frac{1}{{0.182}^{2} \times {10}^{- 8} + 4 {{π}^{2} ( f + 0.418 )}^{2}} + \frac{1}{{0.182}^{2} \times {10}^{- 8} + 4 {{π}^{2} ( f - 0.418 )}^{2}} ] .$$

Probability distribution (2-parameter Weibull distribution) functions of the three lanes are respectively:

$${F}_{1} ( x ) = 1 - {e}^{- {( \frac{x}{63} )}^{2.17}} ;$$

$${F}_{2} ( x ) = 1 - {e}^{- {( \frac{x}{281} )}^{3.05}} ; and$$

$${F}_{3} ( x ) = 1 - {e}^{- {( \frac{x}{210} )}^{2.04}} .$$

In a fourth step, for example, step S4 of FIG. 1, a traffic flow series of each lane is simulated.

It can be learned from a probability statistical analysis result of the third step that the traffic flow series of the three lanes are non-Gaussian stochastic processes w(x) conforming to the 2-parameter Weibull distribution. Therefore, simulation needs to be performed based on the steps in FIG. 2 by using a method combining “probability distribution transformation” and a trigonometric series harmonic synthesis method. Calculation parameters and simulation results in this instance are as follows:

Simulated objective functions are respectively: S_{w}(f)=S₁(f), S₂(f), and S₃(f).

Variances of the Gaussian process g(x) are respectively σ_{g}²=35.9², 89.4², and 93.6².

The power spectral density function of the Gaussian process g(x) is S_{g}(f)=S_{w}(f).

A probability of each discrete value of the simulated Gaussian process is equal to a probability of each discrete value of the non-Gaussian process, w(x)=F_{w}⁻¹(F_{G}(g(x))).

A quantity of simulation times is i=3.

A simulation result is S_{w}⁽³⁾(f)≈S₂(f).

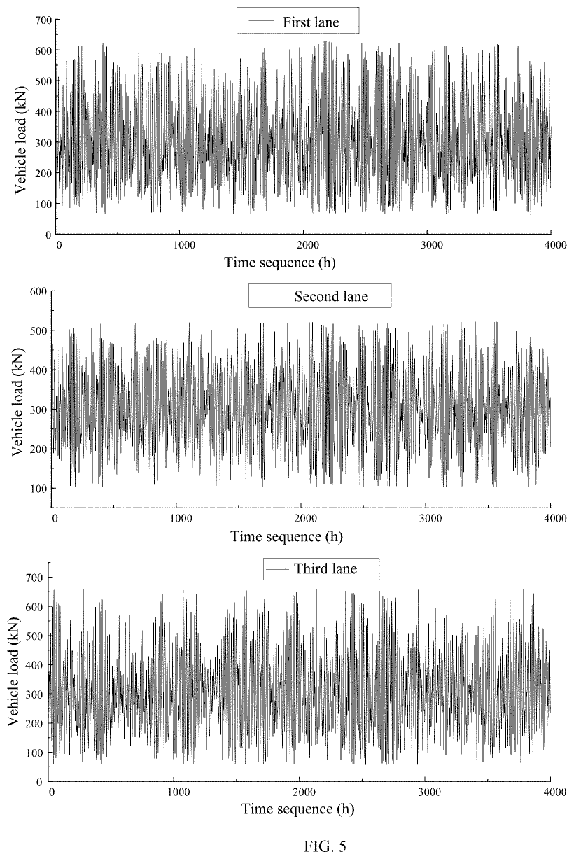

The traffic flow series (a one-dimensional vehicle load spectrum) of the lanes are shown in FIG. 5.

In a fifth step, for example, step S5 of FIG. 1, a two-dimensional over-limit vehicle load spectrum is generated.

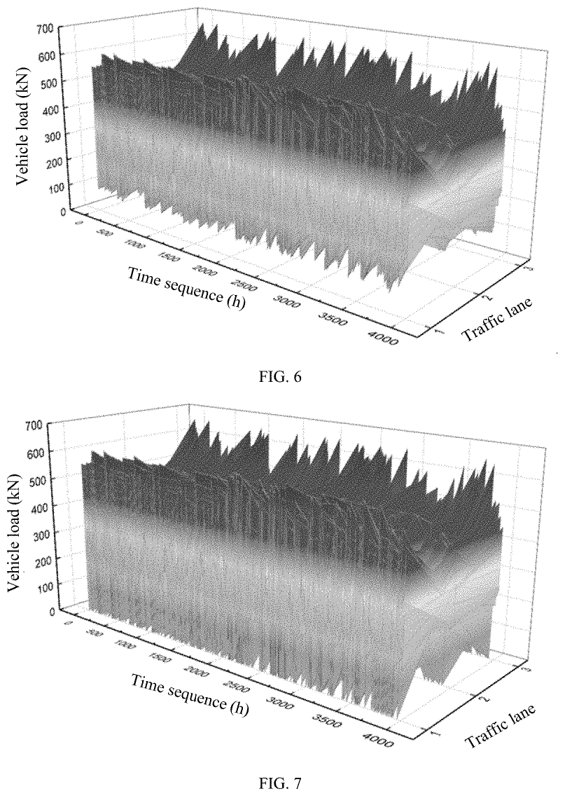

Simulated traffic flow series (a one-dimensional vehicle load spectrum) that pass through the lanes on a section of a road or a bridge at the same time are arranged based on a lane sequence, to generate the two-dimensional over-limit vehicle load spectrum that can reproduce a vehicle passing time and a lane location, as shown in FIG. 6.

In a sixth step, for example, step S6 of FIG. 1, the two-dimensional over-limit vehicle load spectrum is graded, including the following steps. A fatigue limit is determined. Based on a related specification, an infinite life of a general RC member (a 20-meter hollow slab girder is used as an instance in this example) of a road bridge is N_{f}2×10⁶. Then, based on a fatigue experimental curve (an S˜N curve) of the RC member under a constant amplitude cyclic load, after a structural safety coefficient is considered, a fatigue limit (represented by using a bending moment, M_{Sf}), corresponding to N_{f}, of the RC member may be obtained and is:

M_{Sf}=R_{f}(M_{cu}−M₁)/K,

where R_{f}=0.576 is a relative fatigue limit of the RC member, K=1.8 is the structural safety coefficient, and M_{cw} and M₁ are respectively a bending moment limit and a dead load bending moment of the 20-meter hollow slab girder. Based on the “Code for Design of Highway Reinforced Concrete and Prestressed Concrete Bridges and Culverts” (JTGD62-2004), it can be obtained through calculation that M_{cu}=2.308 kN·m and M₁=860 kN·m. Therefore, M_{S}=463 kN·m.

Calculation and defining of over-limit includes, when the 20-meter hollow slab girder is bent, it is obtained through calculation that a critical bending moment obtained when a tensile stress is applied on a concrete lower limb (a location of a maximum tensile stress) thereof is M_{c1}=1300 kN·m.

A bearing capacity limit (bending moment) of the slab girder after the structural safety coefficient (K=1.8) is M_{c2}=1282kN·m.

After a transverse distribution coefficient η=0.549 is considered, a critical over-limit bending moment under the action of a live load of a vehicle is

$${M}_{c} = \frac{{M}_{C 2} - {M}_{1}}{η} = 769 kN \cdot m .$$

A critical over-limit value, corresponding to the critical over-limit bending moment M_{c}, of a vehicle load is marked as S_{c}(P_{c}, σ_{c}). Then, all vehicle loads of S≥S_{c} are defined as over-limit. Because calculation of S_{c} is related to a quantity of axles and a speed of a vehicle, namely, S_{c} has different values for different quantities of axles and speeds, for convenience, in this example, a vehicle load spectrum is graded by using the critical over-limit bending moment Mc as a parameter.

Grading of a load spectrum includes an upper limit S_{1,max} of a first-level load (a bending moment) is S_{1,max}=M_{Sf}=463 kN·m. A second-level load (a bending moment) is greater than M_{Sf} and less than the critical over-limit bending moment Mc, namely, an upper limit thereof is S_{2,max}<Mc=769 kN·m. A third-level load (a bending moment) is greater than or equal to a critical over-limit bending moment Mc, and less than or equal to 110% of the bending moment, namely, an upper limit of the third-level load is S_{3,max}=1.1 Mc=846 kN·m. A fourth-level load (a bending moment) is greater than S_{3,max}, and an upper limit is 125% of the bending moment, namely, an upper limit of the fourth-level load is S_{4,max}=1.25 Mc=961 kN·m. A lower limit of a fifth-level load (a bending moment) is more than 125% of the bending moment, namely, the fifth-level load is S₅>961 kN·m.

In a seventh step, for example, step S7 of FIG. 1, compile the two-dimensional over-limit vehicle load spectrum.

According to the foregoing method for grading the two-dimensional over-limit vehicle load spectrum, a load value (namely, a live load, S≤S_{f}, of a vehicle corresponding to ≤M_{Sf}463 kN·m) of the first-level load, which barely affects a fatigue life of a bridge structure, in a load spectrum is set to zero, and a needed two-dimensional over-limit vehicle load spectrum is compiled based on a sequence and locations in the original load spectrum. In an example, FIG. 7 shows a segment of a two-dimensional over-limit vehicle load spectrum obtained when there are three axles and a speed is 60 km/h. A live load of a vehicle corresponding to the fatigue limit of the 20-meter hollow slab girder is S_{f}=140.3 kN.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A method for simulating, grading, and compiling a two-dimensional over-limit vehicle load spectrum, comprising the following steps:
continuously acquiring traffic flow information of various typical roads for a period of time;
generating a traffic flow series of each lane, and determining an optimal sample capacity of a traffic flow;
analyzing a probability feature of the traffic flow series of each lane;
simulating the traffic flow series of all the lanes;
generating a two-dimensional over-limit vehicle load spectrum;
grading the two-dimensional over-limit vehicle load spectrum; and
compiling the two-dimensional over-limit vehicle load spectrum,
wherein determining the optimal sample capacity of the traffic flow comprises:
setting a statistical analysis precision based on a probability that an over-limit vehicle occurs in statistical data of a traffic flow of each lane,
calculating an exceedance probability of a needed quantity of over-limit vehicles, and
determining a minimum sample capacity, to determine the optimal sample capacity;
wherein analyzing the probability feature of the traffic flow series of each lane comprises:
obtaining traffic flow series data, corresponding to the optimal sample capacity, of each lane based on the determined optimal sample capacity,
calculating and determining a power spectral density function or an autocorrelation function thereof, and
determining a probability distribution function thereof;
wherein generating the two-dimensional over-limit vehicle load spectrum comprises:
arranging, based on a lane sequence, simulated traffic flow series that pass through the lanes on a section of a road or a bridge at the same time, to generate the two-dimensional over-limit vehicle load spectrum that can reproduce a vehicle type/load,
a vehicle passing time, and a lane location;
wherein grading the two-dimensional over-limit vehicle load spectrum comprises:
grading the two-dimensional over-limit vehicle load spectrum based on a degree of a damage caused by a constant amplitude load equivalent to an over-limit of a vehicle to a bridge structure and an over-limit defining method; and
wherein compiling the two-dimensional over-limit vehicle load spectrum comprises:
setting load values of all first-level loads in a load spectrum to zero based on the grading the two-dimensional over-limit vehicle load spectrum, and then compiling the two-dimensional over-limit vehicle load spectrum based on a sequence and locations in the original load spectrum.

2. The method according to claim 1, wherein the various typical roads comprise a national highway, a city expressway, an expressway, and other roads, and acquiring traffic flow information comprises:
using a dynamic vehicle weighing system, a snapping system, or a manual counting method;
wherein the traffic flow information comprises a license plate number, a passing time, a lane, a vehicle type, an axle weight, a gross weight, and a speed; and
wherein a duration of continuously acquiring the traffic flow information is at least one month.

3. The method according to claim 1, wherein the method includes generating the traffic flow series of each lane by at least one of:
classifying acquired vehicle data into four vehicle types based on a small-sized vehicle, a middle-sized vehicle, a large-sized vehicle, and a passenger and freight trailer, acquiring statistics on a traffic flow passing through each lane on a road segment in a unit time, and generating a traffic flow series of each lane in a same direction; and
calculating load effects of vehicles having different quantities of axles, classifying vehicles having a same quantity of axles into one category, and using a vehicle type corresponding to a highest load effect in each vehicle category as a standard vehicle type of the category; and re-acquiring statistics on acquired traffic flow data of each lane based on the standard vehicle type, to obtain a traffic flow series of each lane in a same direction.

4. The method according to claim 1, wherein the sample precision in the statistical analysis of a traffic flow is [symbol] 0.03˜0.05 and an obtained minimum sample capacity is
$$N = ( 1 - {P}_{e} ) / ( {δ}_{{\hat{}}_{{P}_{e}}}^{2} {P}_{e} ) ,$$
wherein:
an exceedance probability of a needed quantity of over-limit vehicles in statistical samples is Pₑ=Nₒ/Nₚ, Nₒ is a quantity of over-limit vehicles passing through a lane in a pre-statistical time t, and Nₚ is a total quantity of vehicles passing through the lane in the same time;
if N≤Nₚ, N=Nₚ, a statistical time is set to t, and in this case, N is an optimal sample capacity; and
if N>Nₚ, the pre-statistical time t is increased until the minimum sample capacity of each lane meets N≤Nₚ.

5. The method according to claim 1, wherein simulating the traffic flow series of all the lanes comprises: determining, based on a probability distribution function of a traffic flow series of a lane, a stochastic process attribute of the traffic flow series of the statistical analysis object, wherein:
if the stochastic process attribute belongs to a Gaussian stochastic process, a probability distribution function and a power spectral density function or an autocorrelation function thereof are used and a numerical simulation method using a trigonometric series harmonic synthesis method is used, to obtain a simulated traffic flow series, comprising an over-limit vehicle, of the lane, namely, a one-dimensional over-limit vehicle load spectrum; or
if the stochastic process attribute of the traffic flow series is a non-Gaussian stochastic process, a simulation method combining probability distribution transformation and a trigonometric series harmonic synthesis method is used, and a power spectral density function of the non-Gaussian process is used as a simulation target, to obtain a simulated traffic flow series, comprising an over-limit vehicle, belonging to the non-Gaussian stochastic process, of the lane, namely, a one-dimensional over-limit vehicle load spectrum, through probability distribution transformation and by correcting the power spectral density function; and
traffic flow series, comprising over-limit vehicles, of all the lanes are simulated based on the method for simulating a traffic flow series of a lane.

6. The method according to claim 5, wherein the simulation method combining the probability distribution transformation and the trigonometric series harmonic synthesis method comprises the following steps:
using the power spectral density function of the non-Gaussian process as a simulation objective function;
setting an average value of a Gaussian process to zero, wherein a variance thereof is equal to a variance of the non-Gaussian process;
simulating the Gaussian process by using the objective function;
assuming that a probability of each discrete value of the simulated Gaussian process is equal to a probability of each discrete value of the non-Gaussian process, and simulating the non-Gaussian process;
calculating a power spectral density function of the simulated non-Gaussian process, and comparing the power spectral density function with the objective function; and
if the power spectral density function is consistent with the objective function, wherein an error is less than 3%, ending a simulation process; or
if the power spectral density function is inconsistent with the objective function, correcting a power spectral density function of the Gaussian process in this step by using the objective function and the power spectral density function used for simulating the non-Gaussian process, and then, performing the step of simulating the Gaussian process by using the objective function, to simulate the Gaussian process until the power spectral density function of the simulated non-Gaussian process is substantially consistent with the objective function.

7. The method according to claim 6, wherein in a process of probability distribution transformation, the power spectral density function of the Gaussian process is corrected for one to three times.

8. The method according to claim 1, wherein grading the two-dimensional over-limit vehicle load spectrum comprises:
an upper limit of a first-level load is a result of dividing a fatigue limit of a bridge member under a constant amplitude fatigue load by a safety coefficient;
an upper limit of a second-level load is a critical over-limit value of a vehicle;
an upper limit of a third-level load is a value exceeding the critical over-limit value by 10%;
an upper limit of a fourth-level load is a value exceeding the critical over-limit value by 25%; and
a lower limit of a fifth-level load is a value exceeding the critical over-limit value by more than 25%.

9. The method according to claim 8, wherein determining a fatigue limit of a bridge member comprises: determining an infinite life N_{f} thereof based on a related specification, and determining a fatigue limit S_{f} thereof corresponding to N_{f} based on a fatigue experiment curve or a classical fatigue equation of a same material or member under a constant amplitude fatigue load.

10. The method according to claim 8, wherein defining the critical over-limit comprises:
for a reinforced concrete member, a smaller value in a critical bending moment obtained when a tensile stress is applied on a concrete lower limb, namely, a location of a maximum tensile stress, of a bending member and a bearing capacity limit obtained after a structural safety coefficient is considered is used as a critical bending moment for defining over-limit, and a vehicle load corresponding to a value greater than or equal to the bending moment is defined as over-limit; and
for a steel structural member and another structural member, a bearing capacity limit obtained after a structural safety coefficient is considered is used as a critical stress for defining over-limit, and a vehicle load corresponding to a value greater than or equal to the stress value is defined as over-limit.
